(19) United States
(12) Patent Application Publication
(10) Pub. No.: US 2024/0320946 A1
(43) Pub. Date: Sep. 26, 2024

(54) ASYMMETRIC AND PROGRESSIVE 360-DEGREE VIDEO ZONE-BASED STREAMING

(71) Applicant: Adeia Guides Inc., San Jose, CA (US)

(72) Inventor: Eun-Seok Ryu, Seoul (KR)

(21) Appl. No.: 18/125,267

(22) Filed: Mar. 23, 2023

(51) Int. Cl. G06V 10/25; G02B 27/01; G06T 7/11

(52) U.S. Cl. CPC G06V 10/25; G02B 27/0172; G06T 7/11; G06V 2201/07

(57) ABSTRACT

System and method are provided for video streaming. The system determines (i) a first partitioning of a portion of video content into a first set of zones having a first zone size and (ii) a second partitioning of the portion of video content into a second set of zones having a second zone size smaller than the first zone size. The system receives a message including a request for the portion of the video content. The system determines a viewport region of interest (ROI) and a plurality of viewport regions based on proximity to the ROI. The system transmits a zone stream for each of the zones in the selection of non-homogenous zones including a first one or more zones within the first viewport region corresponding to the ROI a second one or more zones within the one or more other viewport regions

### BACKGROUND

This disclosure is directed to systems and methods for video streaming.

### SUMMARY

Immersive reality technology is emerging. An immersive streaming service may use 360-degree video streaming to support high quality immersive reality user experience. However, 360-degree video is difficult to stream because of the large amount of content, requiring high bandwidth and causing long latency.

In one approach, 360-degree video content can be divided into tiles and portions of the video content can be transmitted. Instead of streaming entire 360-degree video content to each client, a server divides 360-degree video content into tiles and transmits a portion of the content corresponding to a viewport of a client to reduce bandwidth. A viewport refers to a portion of the area of the 360 degree video frame displayed on an extended reality (XR) device. An XR device may be a Virtual Reality (VR), Mixed Reality (MR), or Augmented Reality (AR) headset or head mounted display (HMD). Using the viewport-adaptive streaming approach, a server can provide tile bitstreams to the client according to a user's viewport movement.

A problem with using the viewport-adaptive streaming approach is large motion-to photon (MTP) latency. MTP latency is the time needed for a user movement to be fully reflected on a display. A low motion-to-photon latency (e.g., <20 ms) helps provide a user with convincing immersion in another place, a phenomenon referred to as “presence,” a state when a user feels as if they are “in” the virtual world they are interacting with. By contrast, a high MTP latency (e.g., >20 ms) results in a lack of presence, and a high enough MTP latency results in cyber sickness. When a user moves wearing an extended reality (XR) headset, the mind expects the screen to be updated correctly to reflect that action. When the screen lags the user movement, the user may experience disorientation and motion sickness, breaking the XR experience for the user.

Another challenge using a viewport-adaptive streaming approach is the load on the server to provide content to multiple clients with different region of interest (ROI). For example, each client may have different ROI when viewing 360 degree content, and a server may have a heavy load to support the requests for different ROI from multiple clients. A relevant issue for the viewport-adaptive streaming approach is the size of the tile that is used. For example, using larger tile sizes makes it easier for a server to react to user's viewport movement due to fewer number of viewport tile update requests. However, a larger tile size wastes bandwidth as the larger tile size includes areas outside of the viewport of the client that are not needed to render a view to the client. The larger tile size also increases computational complexity for decoding larger tile bitstreams. Using smaller tiles reduces the region that is wasted for the viewport. However, smaller tile size increases the number of transactions between server and client for adapting user viewport movement and can increase the MTP latency. In addition, smaller tiles have worse compression performance with less motion prediction compression due to use of a motion-constrained tile set (MCTS). A MCTS technique may be used in viewport-adaptive streaming approach because of motion prediction restriction across tile boundaries. In the viewport-adaptive streaming approach, only portions of video corresponding to the viewport may be sent instead of the entire 360 degree video content. When a viewport changes, the MCTS technique does not rely on tiles having different positions in the previous decoding process than those used for the current viewport. The MCTS allows encoding with constraining motion vectors such that each tile can be decoded and transmitted independently.

To help address these problems, systems and methods are described herein to enable asymmetric and progressive 360-degree video zoning or tilling and streaming. In some embodiments, video images are split with multiple zones or tiles for viewport-based streaming. For examples, a video images may be split into tiles of a first size (large), into tiles of a second size (medium), and into tiles of a third size (small). In some embodiments, asymmetric and progressive tiles are used based on ROI to increase the compression efficiency and to decrease the MTP latency. For example, the system may select larger sized tiles closest to an ROI (e.g., center point) of a viewport, and smaller sized tiles in an area further from the ROI of the viewport. For instance, the system may select large tiles closest to a center point of the viewport, medium tiles next to or surrounding the large sized tile, and small tiles next to or surrounding the medium tiles, further away from the center point of the viewport. This approach can reduce bitrate by selecting tiles to closely overlap with the viewport to send a lower or minimum amount of data to represent or render the viewport. The selection of larger tiles can increase the compression efficiency and decrease the MTP latency while the selection of smaller tiles can decrease or minimize the wasted region.

In some embodiments, a bitstream-level zone-based scheme is used with a coding technique. Different sized zones may be pre-encoded per picture, and each zone may be encoded as a single network abstraction level (NAL) bitstream (e.g., not YUV raw level). A NAL may provide an interface to a video codec to various networks/systems (e.g., DASH). In some embodiments, a zone may refer to any suitable way to divide a picture (frame) or set of pictures into multiple bitstreams (e.g., a tile, a slice, a flexible macroblock order (FMO), a subpicture, etc.). Techniques described herein may implement asymmetric video zoning, wherein, e.g., a video or frame may be divided into zones of different sizes (e.g., rather than zones of equal size). In some instances, the zones within a given frame or video may be different shapes or orientations. Techniques described herein may implement progressive video zoning and streaming. For example, the size, shape, or orientation of zones within a video or frame may depend, at least in part, on the distance of the zones from one or more points or areas of interest. Example points or areas of interest may include a predicted or observed area of focus, a location or position of an object of interest (e.g., objects observed or predicted to draw attention of users), etc.

In some embodiments, a bitstream-level tile scheme is used with High Efficiency Video Coding (HEVC) standards. HEVC may be a video compression standard that replaces redundancies of different parts of a frame of video within a single frame and between consecutive frames with a short description instead of the original pixels. A single frame may be divided into coding tree units (CTUs). A tile may include a sequence of CTUs. Tiles may define horizontal and vertical boundaries that partition a picture into tile columns and rows. Tiles may be similar to slices, and tiles may break in-picture prediction dependencies.

In some embodiments, a bitstream-level subpicture scheme is used with Versatile Video Coding (VVC) standards. Subpictures may be functionally the same as MCTS in HEVC. However, subpictures in VVC may allow motion vectors of a coding block to point outside of the subpicture to enable higher coding efficiency compared to MCTS. Each subpicture may include one or more slices. A video sequence can be coded as multiple independent bitstreams of different resolution.

In some embodiments, the system does not use real-time encoding and transcoding for adapting user viewport movement. The systems and methods enable dynamically adjusting, at the time of encoding, tile arrangements and tile sizes for different regions of a video. The disclosed approach enables increased or optimal responsiveness to unexpected head movements and unanticipated viewport fields of view.

In an embodiment, a disclosed system partitions a single frame or portion of video content multiple times to generate multiple pre-encoded versions of the portion each having a different tile arrangement with different tile sizes. For example, a first version may have a first grid of uniform tiles of a first size, and a second version may have a second grid of uniform tiles of a second size, etc. These versions are pre-encoded and stored, enabling the system to then select dynamically, at the time of encoding and based on proximity to a viewport ROI, tile-streams from the different versions for streaming. For example, a composite tile arrangement, distinct from any of the pre-encoded versions, may be streamed. Advantageously, this system can be implemented to provide dynamic and adaptive non-uniform tiling without predicting viewport fields of view or regions of interest.

In some embodiments, one or more of the versions may include a tile arrangement that may be determined based on predicted ROI or viewport field of view (FoV). For example, the system may pre-encode a single version of a video portion according to a single tile arrangement that may include variable sized tiles. When a user's area of focus is not predicted accurately (e.g., does not correspond to a predicted ROI or viewport FoV), the system may send a tile arrangement of the video portion to the user that is non-optimal (e.g., tile at center of user's viewport may not be large). In other embodiments, each version may not be based on a predicted saliency or ROI. For example, the disclosed system may enable, at the time of encoding, appropriately sized tiles responsive to head movement. This disclosed approach of sending appropriately sized tiles responsive to head movement helps address the earlier problem of sending a non-optimal tile arrangement to a user when based on predicted ROI or viewport FoV.

As a result of the use of these techniques, asymmetric and progressive 360-degree video tiling and streaming may be enabled.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative example of a streaming service system using asymmetric and progressive tiling, in accordance with some embodiments of this disclosure.

FIG. 2A shows an illustrative example of small tiles vs. large tile issues in viewport video tile streaming.

FIG. 2B shows an illustrative example of waste in using large tiles.

FIG. 3 shows an illustrative example of asymmetric tiling and progressive tiling, in accordance with some embodiments of this disclosure.

FIG. 4 shows an illustrative example of tiling for video chunks in a streaming server, in accordance with some embodiments of this disclosure.

FIG. 5 shows an illustrative example of asymmetric and progressive tiling for a viewport area, in accordance with some embodiments of this disclosure.

FIG. 6 shows an illustrative user equipment device, in accordance with some embodiments of this disclosure.

FIG. 7 shows an example system, in accordance with some embodiments of this disclosure.

FIG. 8A is a flowchart of a detailed illustrative process for preparing a server bitstream, in accordance with some embodiments of this disclosure.

FIG. 8B is a flowchart of a detailed illustrative process using asymmetrically and progressively tiling video content for a client device, in accordance with some embodiments of this disclosure.

FIG. 9A is a flowchart of a detailed illustrative process for asymmetric and progressive tiling for viewport area, in accordance with some embodiments of this disclosure.

FIG. 9B is a flowchart of a detailed illustrative process for determining tile-size for video content, in accordance with some embodiments of this disclosure.

FIG. 10 is a flowchart of a detailed illustrative process for determining tile-size for video content, in accordance with some embodiments of this disclosure.

### DETAILED DESCRIPTION

When streaming video, a server provides a client a stream of data. A stream may be thought of as items (e.g., data elements) on a conveyor belt being processed (e.g., the receiving processor or system) one at a time rather than in large batches. Streams are processed differently from batch data. For example, normal functions cannot operate on streams as a whole, as streams have potentially unlimited data. In one example, one or more audio and video compressed bitstreams are combined into a single bit-stream. The bit-stream consists of a compression layer and a system layer, which envelopes the compression layer with control information.

Moving Picture Experts Group (MPEG) codecs utilize both “program streams” and “transport streams.” Program streams are often preferred for content that has a fixed duration (e.g., movie content, TV content, etc.). Transport streams are often preferred for real-time content (e.g., TV broadcasts). An MPEG-2 Program Stream contains only one content channel. An MPEG-2 Transport Stream can contain one or more content channels. To provide more than one channel, the channels may be multiplexed into a single Transport Stream. In such an implementation, the receiver receives all channels at once, but it only demultiplexes and then decodes the selected content, one at a time, from the delivered Transport Stream. When sending MPEG streams over the internet, typically there is less value in having one Transport Stream that contains multiple content channels. It is more useful, flexible, and less bandwidth intensive to provide each content channel with its own IP multicast address. This often leads to a single content Transport Stream for a given content channel.

Video is made up of a sequence of frames. A frame is one of multiple images that, when taken together, result in a moving picture or video. A video frame may be compressed using different algorithms with different advantages and disadvantages, centered mainly around the amount of data compression. Compression may rely on reference frames, which are used as references for predicting other frames in a video. There are three frame types: I, P and B frames. Frames encoded without information from other frames are called I-frames (these are the least compressible of the three frame types). Frames that use prediction from a single preceding reference frame (or a single frame for prediction of each region) are called P-frames. B-frames use prediction from a (possibly weighted) average of two reference frames, one preceding and one succeeding (as a result, B-frames are the most compressible of the three types).

Various MPEG standards support the use of macroblocks. A macroblock is a processing unit that is based on linear block transforms. In a typical example, a macroblock consists of several (e.g., four) blocks. Typically, a block is an 8×8 array of pixels that can be either a chroma type (indicating color information) or a luma type (indicating luminance or brightness information). The block is the basic coding unit in numerous algorithms.

HEVC supports highly flexible partitioning of a video sequence. In a typical example, each frame of the sequence is split up into rectangular or square regions (Units or Blocks), each of which is predicted from previously coded data. After prediction, any residual information is transformed and encoded. Each coded video frame, or picture, is partitioned into tiles and/or slices, which are further partitioned into Coding Tree Units (CTUs). Generally, a tile or slice may be encoded and streamed as a stream independent from other tile streams or slice streams. Regarding slices, in the H.264/MPEG-4 Advanced Video Coding (AVC) standard, the granularity of prediction types is brought down to the “slice level.” A slice (e.g., a set of macroblocks or CTUs) is a spatially distinct region of a frame that is encoded separately from any other region in the same frame. I-slices, P-slices, and B-slices take the place of I, P, and B frames. Slices can be used both for network packetization and for parallel processing. However, a severe penalty on rate distortion performance may be incurred when using slices, due to the breaking of all dependencies at their boundaries and due to the slice header size, a set of parameters that has to be transmitted at the beginning of each slice.

The CTU is a unit of coding, analogous to the Macroblock in other standards, and can be up to 64×64 pixels in size. In some instances, a CTU is referred to as a largest coding unit, or LCU. A CTU can be between 16×16 pixels and 64×64 pixels in size, with a larger size usually increasing coding efficiency. In a typical example, all CTUs in a video sequence have the same size. A CTU can be subdivided into square regions known as Coding Units (CUs) using a quadtree structure. Each CU is predicted using Inter or Intra prediction and transformed using one or more Transform Units.

Regarding tiles, as noted, a frame may be partitioned into multiple tiles. In a typical example, tiles are rectangular groups or sequences of CTUs. Tile boundaries are vertical and horizontal, and they extend across the whole frame. The number of tiles and the location of their boundaries can be defined for the entire sequence or changed from frame to frame. With the use of signaling parameters, the number of tiles, as well as the frame partitioning into tiles, can be defined. Because the tile signaling is included in the picture parameter set (PPS), this structure may change on a per frame or picture basis. This has the benefit that an encoder can use different ways of arranging the tiles in different pictures to control the load balancing between cores used for encoding/decoding. For example, if a region of a picture should require more processing resources, such a region may be subdivided into more tiles than other regions which may require less encoding/decoding resources.

Some codecs support subpictures. The subpicture was developed with VR applications in mind. Generally, each subpicture is a rectangular region of one or more slices within a frame. In typical implementations, each subpicture boundary is also a slice boundary, and every vertical subpicture boundary is always a vertical boundary of some tile. Typically, one of the following holds true: (i) the subpicture's CTUs belong to the same tile; or (ii) all tile's CTUs belong to the same subpicture.

Turning to 360-degree video, 360-degree video is difficult to stream because of the large amount of content, requiring high bandwidth and causing long latency. In one approach, 360-degree video content may be divided into tiles and pre-encoded, and client devices can request a portion of the video content to be sent according to the viewport. In this approach, the 360-degree frame are broken up into rectangular tiles. These tiles are independently encoded as dynamic adaptive streaming (DASH) segments, and a subset of tiles from the full 360-degree segment can be individually served to a user device. During streaming, the video player downloads tiles so that the user's predicted viewports over the segment duration are covered by high-quality tile-segments. Tiles in regions that the user is not expected to observe can be downloaded at lower qualities, if desired, to account for unexpected changes in view orientations by the user. These schemes have the potential to reduce the amount of bandwidth needed for 360-degree video streaming. However, schemes using small tile sizes suffer from poor video compression performance due to poor inter-prediction performance (e.g., because of motion prediction restriction across tile boundaries). Further, while schemes using large tile sizes may have better encoding efficiency than small tile systems, they may suffer from other problems (e.g., using large tile size may have better compression performance but may waste bandwidth by including areas a user is not watching and have increased motion-to photon (MTP) latency).

In one approach, the disclosed techniques enable partitioning of a given portion of video content multiple times to obtain multiple different sets of zones of video content. A portion of video content may be portioned into a set of zones that are sized and arranged according to proximity to a predicted region of interest (ROI). A user device may request a portion of the video content (e.g., based on a current viewport field of view), and a server may transmit zone streams corresponding to the requested portion, resulting in better compression performance and lower MTP latency (e.g., requested portion may correspond to a large tile for the viewport as a result of the accurate ROI prediction or as a result of the server being able to select zones of desirable size). The total selection of zones may differ from any of the pre-encoded versions stored to memory. That is, the composite arrangement may be a “new” arrangement of tiles determined at or near the time of encoding.

In some embodiments, bitstream-level tiling refers to using a NAL bitstream level encoded tile, not a YUV raw-level encoded tile. A picture may be divided into multiple bitstreams using slices, tiles, or subpictures. A video encoder may divide and encode each frame with fixed-size tiles from bigger to small in advance, and a server contains the bitstreams in MPEG DASH or HTTP Live Streaming (HLS). The client requests an appropriate tile bitstream from the server.

In some embodiments, progressive tiling refers to, from area having highest significance (e.g., ROI) to least significance (e.g., furthest from ROI), using progressively smaller tiles.

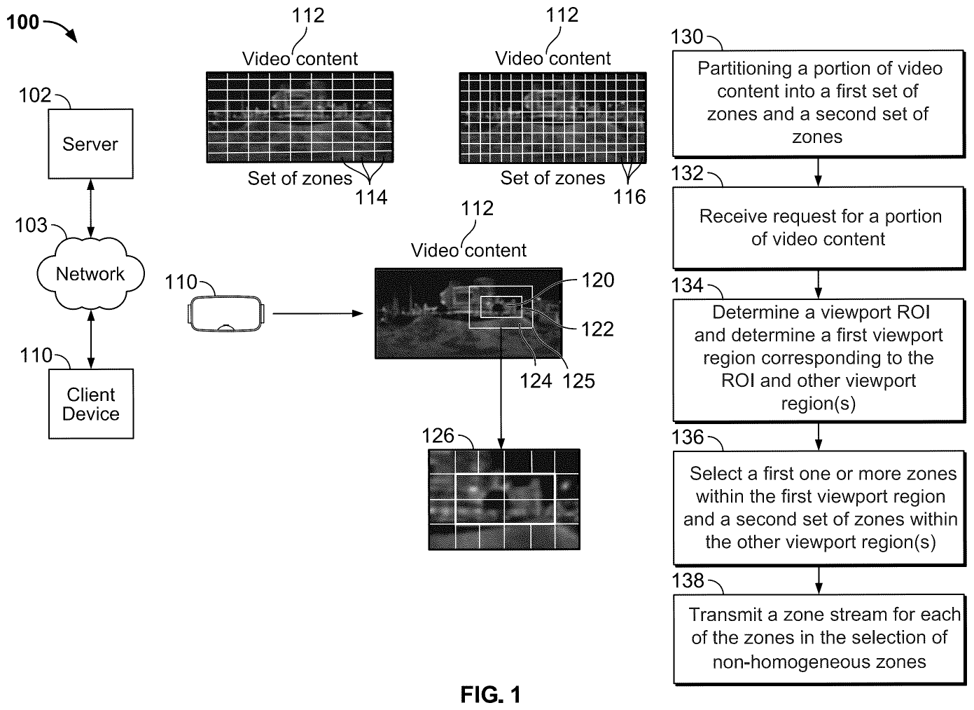

FIG. 1 shows an illustrative example of a streaming service system using asymmetric and progressive tiling, in accordance with some embodiments of this disclosure. The streaming service system 100 includes a server 102, network 103, and client devices 110. In some embodiments, the streaming service system 100 may include different or additional entities. For example, only one server 102 and client device 110 are shown in FIG. 1; however other embodiments may include any suitable number of client devices and servers.

Server 102 is a computer system configured to receive, store, and transmit data to a client device. Client device 110 is a device configured to present video content 112. Client device 110 may be computing device with an XR interface (e.g., head mounted display (HMD)). Client device 110 may receive inputs from a user (e.g., HMD movement, any suitable user movement, or user input via a controller). Client device 110 may request a portion 125 video content 112 from server 102 corresponding to a viewport area. Server 102 may provide the requested portion 125 of video content 112 to client device 110. The data transmitted to or received by different components of system 100 may be transmitted through network 103.

Video content 112 may be 360-degree video content mapped to a 2D video image. For example, equirectangular projection (ERP), cube projection, polyhedron projection, pyramid projection, quartz-based projection (QZP), truncated square pyramid projection (TSP), or any suitable type of projection may be used to map 360-degree video content to a 2D image.

An example process for system 100 is as follows. At 130, the server may partition a portion of video content 112 into a first set of zones 114 and a second set of zones 116. At 132, the server 102 may receive a request for a portion of video content from client device 110 via the network 103. At 134, the server 102 may determine a viewport ROI 120. The server may determine a first viewport region 122 corresponding to the ROI 120. The server may determine other viewport region 124. At 136, the server 102 may select a first one or more zones 114 within the first viewport region 122 and a second set of zones 116 within the other viewport region 124. At 138, the server 102 transmits a zone stream for each of the zones in the selection of non-homogeneous zones.

In some embodiments, additionally or alternatively, the server 102 may use a (deep-learning) DL-based method using viewport dataset to generate a saliency map representing the average users' ROIs corresponding to the video content 112. The server 102 may use deep learning based (DL-based) saliency map estimation based on the viewport dataset. The server 102 may asymmetrically and progressively tile video content based on the saliency map. For example, a large tile may correspond to a region of interest (ROI) area including an ROI object from the saliency map. Medium sized tiles may be used for areas surrounding the ROI area, and smaller tiles may be used for areas further away from the ROI area.

In one approach, viewport video tile streaming (using symmetrically-sized tiles) may be used to support various ROIs (viewports) for multiple users. For example, video content (e.g., an ERP image) may be divided into multiple tiles, and the tiles in the ROI may be transmitted over the network (e.g., internet) to each user. Video coding may support tiling features. For example, HEVC video coding standard such as H.265 may provide a feature “tile” scheme, and VCC video coding standard (H.266) may provide a same or similar “subpicture” scheme. According to the user's viewport movement (e.g., head-mounted display (HMD's) movement), a server may provide adequate tile bitstreams to the client.

However, there are problems with viewport-based 360-degree tile streaming including (1) high motion to photon latency, (2) server-side burden to support multiple users with different region of interest (ROI), and (3) small tiles vs. large tile issue.

A first problem is high MTP latency. A server may transmit the viewport tile according to the user HMD or controller's movement which may cause relatively long MTP latency. In one approach, a low quality bitstream that covers the entire ERP area may accompany the viewport tiles in streaming to reduce the MTP latency. In another approach, tile prefetching may be used to reduce MTP latency. However, next tile estimation and supporting multiple users may be challenging.

A second problem is the server-side burden to support multiple users with different ROI. For example, multiple users may request various tile bitstreams, and a server may be busy to react to the requests. In one approach, client-driven streaming may be used to reduce server-side burden. For example, MPEG DASH or any suitable technique for client-driven streaming may be used.

A third problem is small tiles vs. large tiles issue. For example, ERP and tiling scheme may be used for 360-degree video. If the tile size is large, there may be a smaller number of viewport tile update requests. However, bandwidth may be wasted because an edge area of a big tile may not be needed to render a viewport of the user. Small tiles may reduce the wasted region for the viewport, but show lesser motion prediction compression because of a motion-constrained tile set (MCTS). In video compression, if the tile size is small, inter-prediction performance is not good because of motion prediction restriction across tile boundaries. Thus, larger tiles show better compression performance for VR tiled streaming. However, if the streaming system uses larger tiles only, bandwidth is wasted for streaming an area that a user is not watching. Larger tiles also increases the computational complexity for decoding a larger tile bitstream. A small tile size decreases the video compression performance and increases the number of transactions between the server and client for adapting user viewport movement. Smaller tile size can increase MTP latency while decreasing the wasted area of tile that the user is not watching. A fixed tile-size may have disadvantages in (1) compression performance, (2) MTP latency, and (3) computational complexity.

Tiling is relevant for reducing the streaming bandwidth by enabling a portion of the 360-degree video content to be transmitted. Viewport adaptation is relevant for adapting user ROI and increasing the quality of ROI. Also relevant is reducing or minimizing MTP latency.

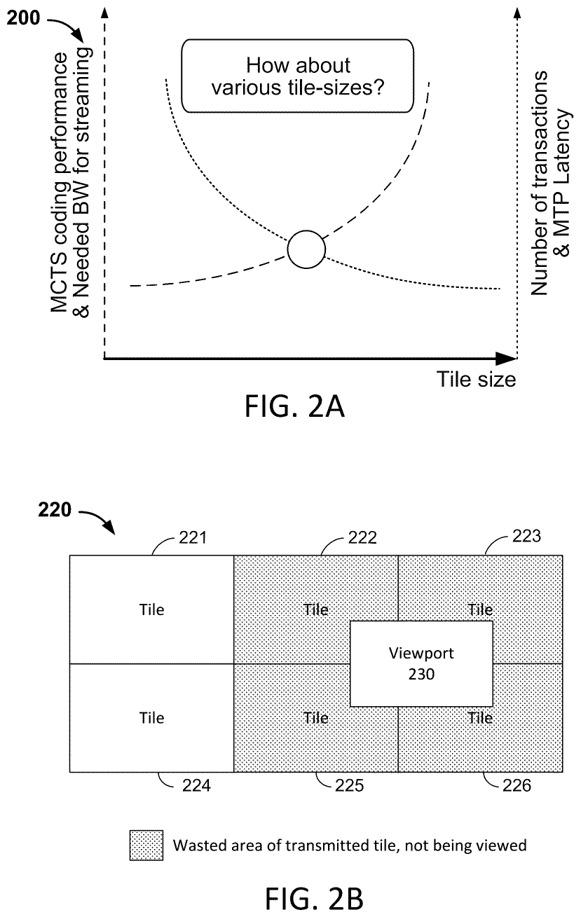

FIG. 2A shows an illustrative example of small tiles vs. large tile issue in viewport video tile streaming, in accordance with some embodiments of this disclosure. The curve corresponding to the axis on the left indicates that as the tile-size is increased, inter-picture coding performance is increased as well as the needed bandwidth for streaming. For example, a motion constrained tile set (MCTS) coding performance increases with increasing tile size. The curve corresponding to the axis on the right indicates that as tile-size decreases, the number of transactions increases and the MTP latency increases.

In some embodiments, tiling is not YUV raw level tiling but Network Access Layer (NAL) bitstream level tiling. In some embodiments, motion-constrained tile set (MCTS) technology in MPEG video standard such as HEVC may be used. In versatile video coding (VCC), the concept may also be applied to subpicture coding.

FIG. 2B shows an illustrative example 220 of waste in using large tiles. In video compression, if the tile size is small, inter-prediction performance is not good because of motion prediction restriction across the tile boundaries. Thus, larger tiles show better compression performance for VR tiled streaming. However, if the VR streaming system uses larger tiles only, a lot of bandwidth is wasted for streaming the area the user is not watching as shown in FIG. 2B. The computational complexity also increases for decoding the larger tile bitstreams. In contrast, smaller tile size decreases the video compression performance and increases the number of transactions between server and client for adapting user viewport movement. The smaller tile size can increase MTP latency while decreasing the wasting area of tile user is not watching. In traditional and current VR streaming, the fixed tile-size may be used for a simple implementation.

As an example, FIG. 2B shows a viewport 230. Reacting to the user's viewport 230 may have a small number of viewport tile update requests (e.g., four tiles 222, 223, 225 and 226). However, the large tile size may waste bandwidth because of the wasted area of transmitted tile which is not being viewed. For example, viewport 230 overlaps a small portion of tiles 222, 223, 225 and 226. The non-overlapping area of tiles 222, 223, 225 and 226 is wasted as it is not needed to render the viewport 230.

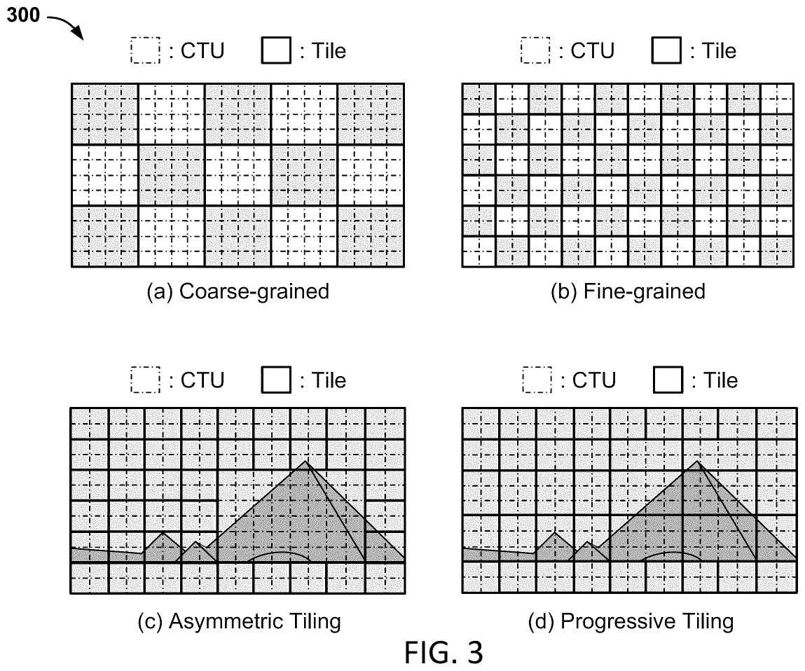

FIG. 3 shows an illustrative example 300 of asymmetric tiling and progressive tiling, in accordance with some embodiments of this disclosure.

FIG. 3 shows (a) coarse-grained tile and (b) fine-grained tiles. Each tile may be made of coding tree units (CTUs). For example, a coarse-grained tile may be made of 4×4 CTUs, and a fine-grained tile may be made of 2×2 CTUs. In one embodiment, coarse-grained tiles are selected for a saliency area and fine-grained tiles for the other edge areas. FIG. 3 shows (c) asymmetric tiling. Different resolutions and asymmetric shapes may be used for the saliency area tiles as shown in FIG. 3. Different quantization parameter (QP) values can be applied to the tiles. Progressive tiling (d) may refer to gradually changing the size and quality of tiles of areas neighboring the saliency area, using fine-grained tiles in areas furthest away from the saliency area. The asymmetric and progressive tiling can provide better performance in one-to-many server and client structure.

In some embodiments, user preference viewport determination can use (1) a deep learning-based saliency map and/or (2) real-time statistics for multiple users.

In some embodiments, MPEG-DASH streaming may be used. For example, in MPEG-DASH streaming, short video chunks are used and Low-delay P (LDP) or Low-delay B (LDB) video coding structures are used to reduce the tile-switching latency. In some embodiments, adjacent tiles may be pre-fetched and decoded in parallel first. If the adjacent tiles need to be rendered in the middle of video chunks, the decoded video may be immediately rendered for viewport adaptation.

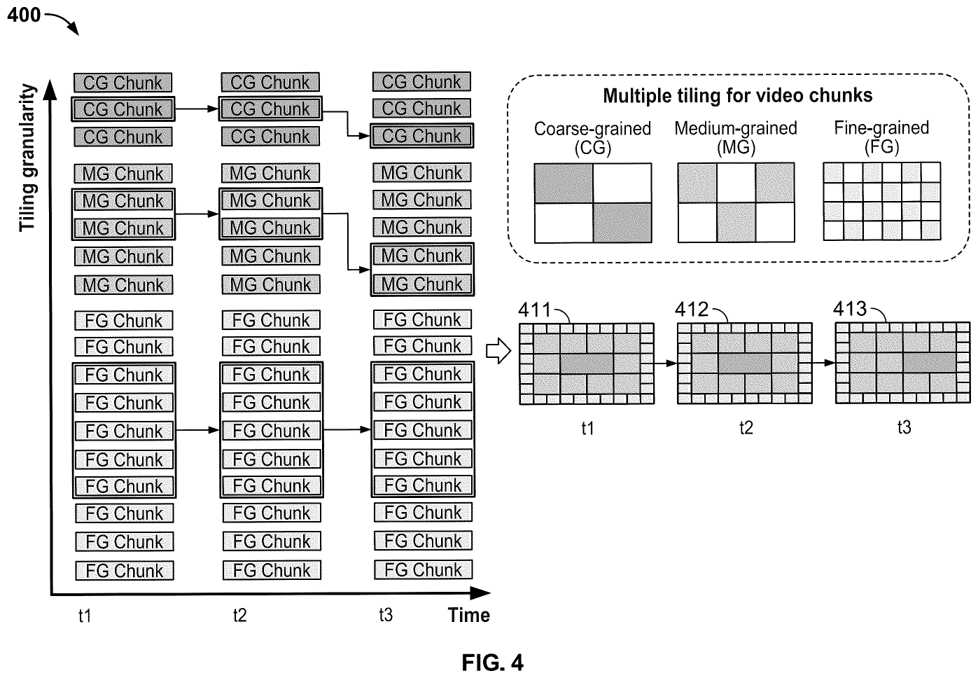

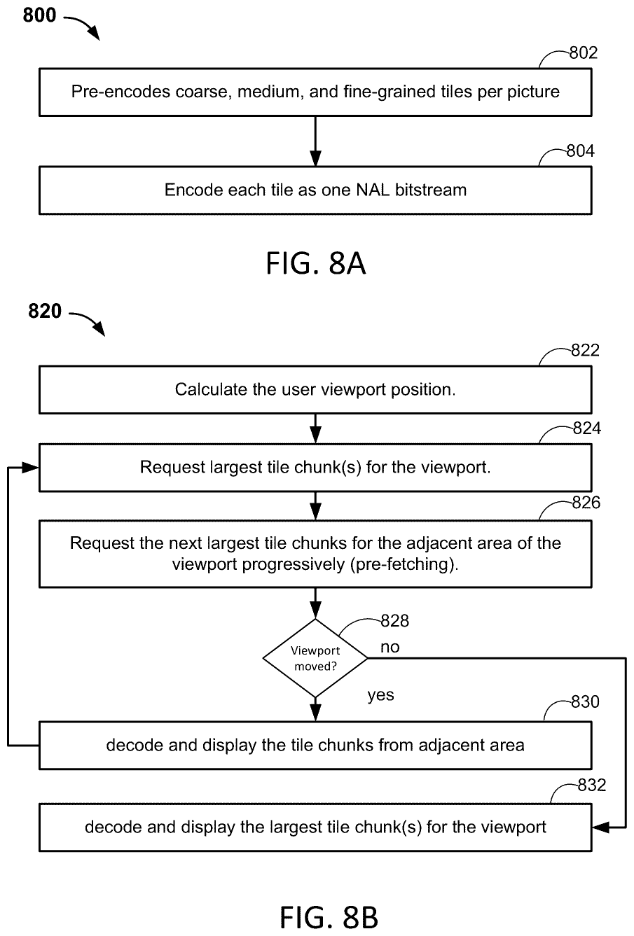

FIG. 4 shows an illustrative example 400 of tiling for video chunks in a streaming server, in accordance with some embodiments of this disclosure. In some embodiments, a server may prepare server bitstreams by performing the following process steps: (1) pre-encoding the coarse, medium, and fine-grained tiles per picture and (2) encoding each (one) tile as a (one) NAL bitstream. Additional detail for the example process may be found in the description of FIG. 8A.

In some embodiments, a client device may perform the following steps. The client device may, at step 1—calculate the user viewport position, at step 2—request the largest tile chunk(s) for the viewport, at step 3—request the next largest tile chunks for the adjacent area of the viewport progressively (pre-fetching), and at step 4—if viewport moves, decode and display the tile chunks from adjacent area first and move to step 2. Note that in step 4, if viewport moves, the client device may calculate the user viewport position in step 4 which is applied afterwards in step 2. If the viewport does not move, the client device may decode and display the largest tile chunk(s) for the viewport. In response to the client device request, a server may provide the chunks to the client device. Additional detail for the example process may be found in the description of FIG. 8B.

As an example, FIG. 4 shows that video chunks representing a portion of a frame corresponding to a viewport may change with viewport movement. For example at time t1 and t2, a viewport has not moved, and the video chunks selected for the portion of the frame 411 and 412 corresponding to the viewport may correspond to a same respective position in the frame. However, at time t3, a viewport may have moved, and a video chunk position may change. For example, requested coarse-grained chunk may change to a neighboring chunk position, and requested medium-grained chunks may have shifted in position (e.g., exclude the position of one that was previously included and include an adjacent one). The requested fine-grained chunks may correspond to ones at the same positions for viewport 411, 412, and 413 at time t1, t2, and t3, respectively.

After progressive encoding multiple times for coarse-grained (CG), medium-grained (MG), and fine-grained (FG) chunks, the server includes multiple CG, MG, and FG chunks for the video content. When user HMD moves, the client requests chunks for the viewport of user. For viewport area, the client receives CG chunks, for the other areas, the client receives MG and FG chunks. Thus, without real-time encoding or transcoding, the disclosed tiling method can provide viewport-based video tile streaming.

When user viewport moves, the client (e,g, HMD) requests the largest tile bitstream chunk. At the same time, the client displays the adjacent smaller bitstream chunk or (optionally) accompanied low-quality bitstream covering whole area. With the disclosed method, pre-fetching techniques can be used together.

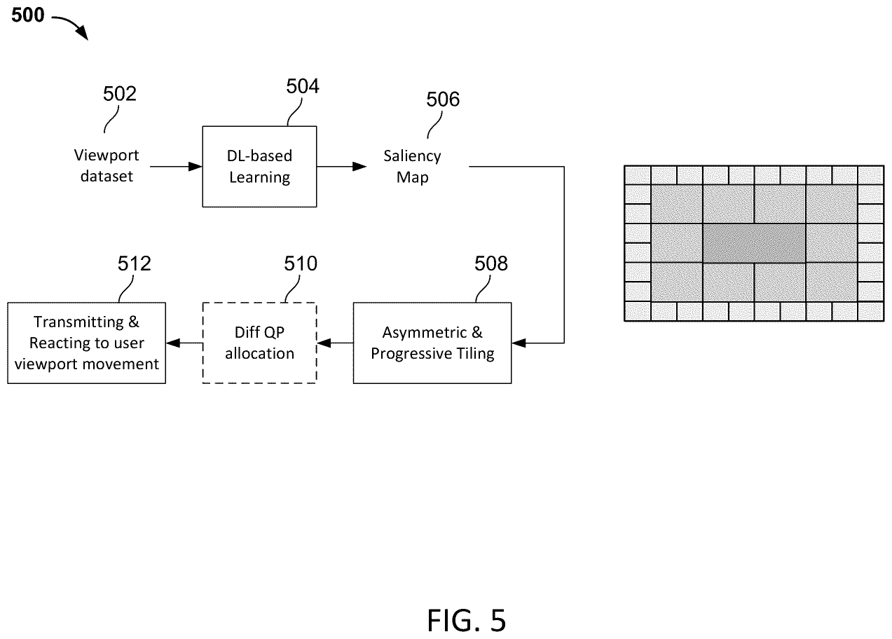

FIG. 5 shows an illustrative example of asymmetric and progressive tiling for a viewport area, in accordance with some embodiments of this disclosure. Because the disclosed approach tiles the ERP texture (image) progressively, reaction to the user viewport movement may be quick with pre-fetched tiles. The area far from a central area of the viewport is FG to reduce the wasting area of tile when user views ROI area mostly and looks around sometimes. The MTP latency may also be reduced.

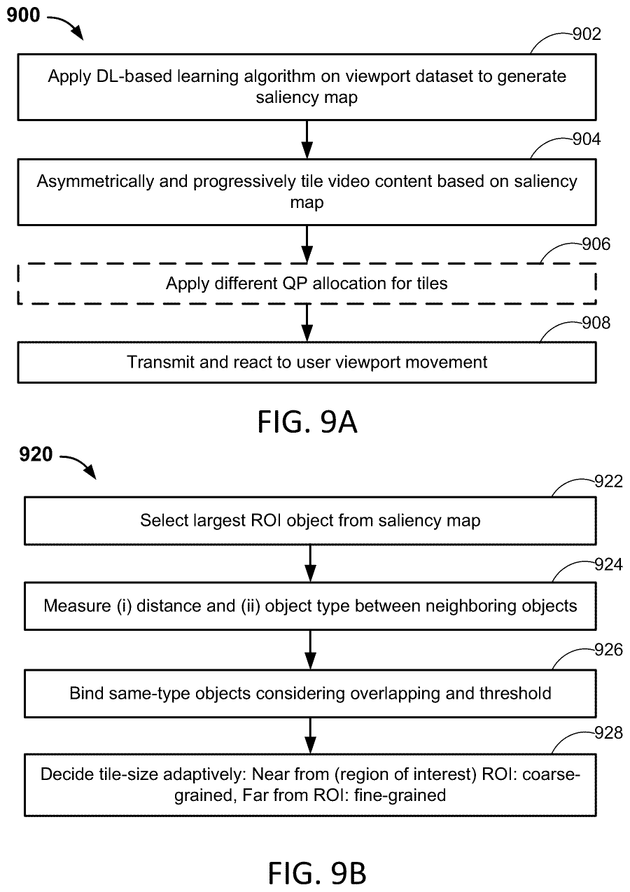

The system includes a server and a client with HMD. In the server side, viewport dataset 502 is used for DL-based learning 504 and generates the saliency map 506 which may represent the average users' ROIs. Based on the saliency map 506, the disclosed tiling method splits the video image with tiles in asymmetric and progressive ways 508. For pre-encoding each tile, the server optionally allocates 510 the different QP values (lower QP for ROIs) when the DL-based saliency map estimation is applied to find ROI in advance. The system may have an MPEG DASH server and client, and the system may provide a client-driven 360-degree VR streaming services with low bandwidth requirement and low MTP latency. The system may transmit and react to user viewport movement 512. Additional detail for the example process may be found in the description of FIG. 9A.

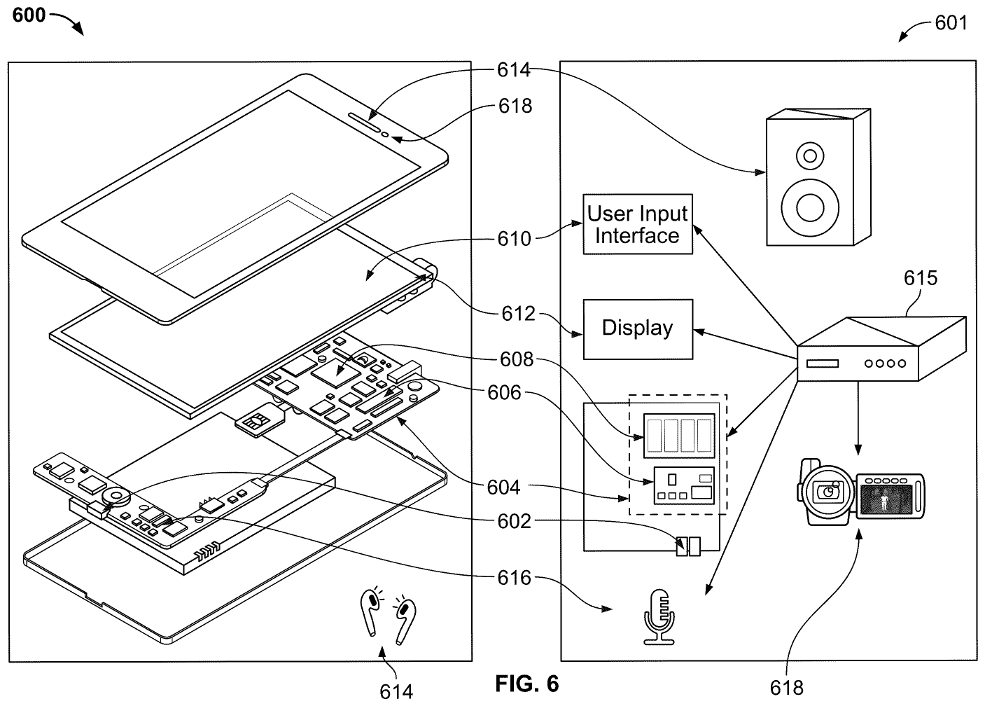

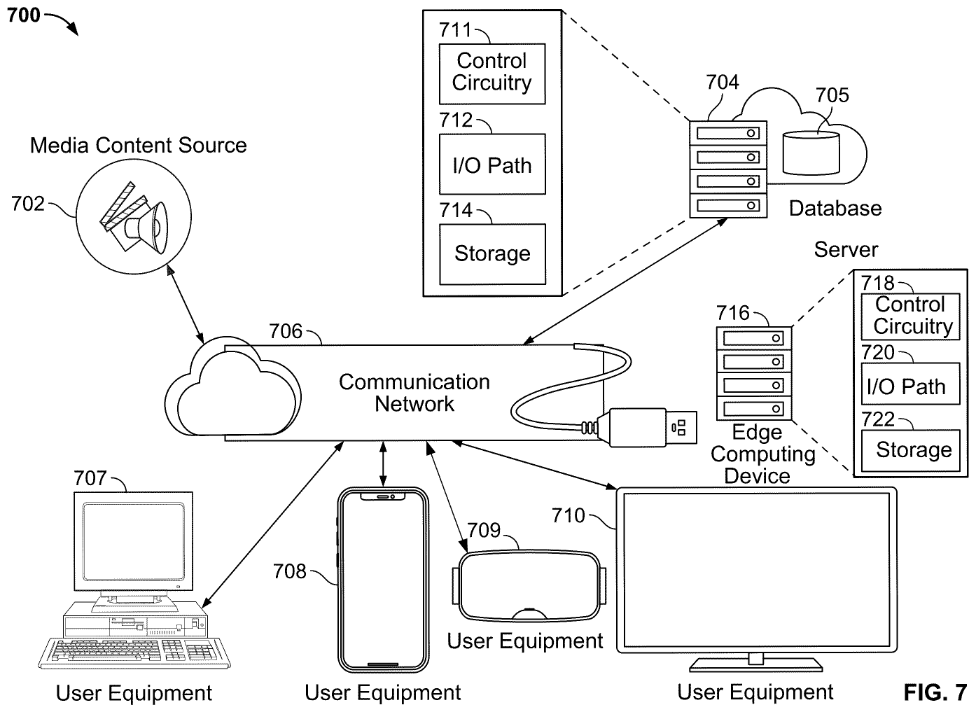

FIGS. 6-7 depict illustrative devices, systems, servers, and related hardware for asymmetric and progressive 360-degree video zone-based streaming. FIG. 6 shows generalized embodiments of illustrative user equipment devices 600 and 601. For example, user equipment device 600 may be a smartphone device, a tablet, a virtual reality or augmented reality device, or any other suitable device capable of processing video data. In another example, user equipment device 601 may be a user television equipment system or device. User television equipment device 601 may include set-top box 615. Set-top box 615 may be communicatively connected to microphone 616, audio output equipment (e.g., speaker or headphones 614), and display 612. In some embodiments, display 612 may be a television display or a computer display. In some embodiments, set-top box 615 may be communicatively connected to user input interface 610. In some embodiments, user input interface 610 may be a remote-control device. Set-top box 615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path.

Each one of user equipment device 600 and user equipment device 601 may receive content and data via input/output (I/O) path (e.g., circuitry) 602. I/O path 602 may provide content (e.g., broadcast programming, on-demand programming, Internet content, content available over a local area network (LAN) or wide area network (WAN), and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing. While set-top box 615 is shown in FIG. 6 for illustration, any suitable computing device having processing circuitry, control circuitry, and storage may be used in accordance with the present disclosure. For example, set-top box 615 may be replaced by, or complemented by, a personal computer (e.g., a notebook, a laptop, a desktop), a smartphone (e.g., device 700), a tablet, a network-based server hosting a user-accessible client device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for the immersive video application stored in memory (e.g., storage 608). Specifically, control circuitry 604 may be instructed by the immersive video application to perform the functions discussed above and below. In some implementations, processing or actions performed by control circuitry 604 may be based on instructions received from the immersive video application.

In client/server-based embodiments, control circuitry 604 may include communications circuitry suitable for communicating with a server or other networks or servers. The immersive video application may be a stand-alone application implemented on a device or a server. The immersive video application may be implemented as software or a set of executable instructions. The instructions for performing any of the embodiments discussed herein of the immersive video application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a device 600.

In some embodiments, the immersive video application may be a client/server application where only the client application resides on device 600, and a server application resides on an external server (e.g., server 704 and/or server 716). For example, the immersive video application may be implemented partially as a client application on control circuitry 604 of device 600 and partially on server 704 as a server application running on control circuitry 711. Server 704 may be a part of a local area network with one or more of devices 600 or may be part of a cloud computing environment accessed via the internet. In a cloud computing environment, various types of computing services for performing searches on the internet or informational databases, providing zone based streaming capabilities, providing storage (e.g., for a database) or parsing data (e.g., using machine learning algorithms described above and below) are provided by a collection of network-accessible computing and storage resources (e.g., server 704 and/or edge computing device 716), referred to as “the cloud.” Device 700 may be a cloud client that relies on the cloud computing capabilities from server 704 to determine whether processing (e.g., at least a portion of virtual background processing and/or at least a portion of other processing tasks) should be offloaded from the mobile device, and facilitate such offloading. When executed by control circuitry of server 704 or 716, the immersive video application may instruct control 711 or 718 circuitry to perform processing tasks for the client device and facilitate the zone based streaming capabilities.

Control circuitry 604 may include communications circuitry suitable for communicating with a server, edge computing systems and devices, a table or database server, or other networks or servers. The instructions for carrying out the above mentioned functionality may be stored on a server (which is described in more detail in connection with FIG. 6). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as immersive video application data described above. Nonvolatile memory may also be used (e.g., to launch a boot-up routine and other instructions). Cloud-based storage, described in relation to FIG. 6, may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of user equipment 600. Control circuitry 604 may also include digital-to-analog converter circuitry and analog-to-digital converter circuitry for converting between digital and analog signals. The tuning and encoding circuitry may be used by user equipment device 600, 601 to receive and to display, to play, or to record content. The tuning and encoding circuitry may also be used to receive video zone based streaming data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment device 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment device 600 and user equipment device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 615.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of device 600 and equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

The immersive video application may be implemented using any suitable architecture. For example, it may be a stand-alone application wholly-implemented on each one of user equipment device 600 and user equipment device 601. In such an approach, instructions of the application may be stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to provide zone based streaming functionality and preform any of the actions discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the immersive video application is a client/server-based application. Data for use by a thick or thin client implemented on each one of user equipment device 600 and user equipment device 601 may be retrieved on-demand by issuing requests to a server remote to each one of user equipment device 600 and user equipment device 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on device 600. This way, the processing of the instructions is performed remotely by the server while the resulting displays (e.g., that may include text, a keyboard, or other visuals) are provided locally on device 600. Device 600 may receive inputs from the user via input interface 610 and transmit those inputs to the remote server for processing and generating the corresponding displays. For example, device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to device 600 for presentation to the user.

In some embodiments, the immersive video application may be downloaded and interpreted or otherwise run by an interpreter or virtual machine (run by control circuitry 604). In some embodiments, the immersive video application may be encoded in the ETV Binary Interchange Format (EBIF), received by control circuitry 604 as part of a suitable feed, and interpreted by a user agent running on control circuitry 604. For example, the immersive video application may be an EBIF application. In some embodiments, the immersive video application may be defined by a series of JAVA-based files that are received and run by a local virtual machine or other suitable middleware executed by control circuitry 604. In some of such embodiments (e.g., those employing MPEG-2 or other digital media encoding schemes), immersive video application may be, for example, encoded and transmitted in an MPEG-2 object carousel with the MPEG audio and video packets of a program.

FIG. 6 is a diagram of an illustrative system 700 for enabling zone based streaming, in accordance with some embodiments of this disclosure. User equipment devices 707, 708, 709, 710 (e.g., which may correspond to one or more of computing device 212 may be coupled to communication network 706). Communication network 706 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 706) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 6 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11×, etc.), or other short-range communication via wired or wireless paths. The user equipment devices may also communicate with each other directly through an indirect path via communication network 706.

System 700 may comprise media content source 702, one or more servers 704, and one or more edge computing devices 716 (e.g., included as part of an edge computing system, such as, for example, managed by mobile operator 206). In some embodiments, the immersive video application may be executed at one or more of control circuitry 711 of server 704 (and/or control circuitry of user equipment devices 707, 708, 709, 710 and/or control circuitry 718 of edge computing device 716). In some embodiments, a data structure of FIGS. 1, 3, and/or 4 may be stored at database 705 maintained at or otherwise associated with server 704, and/or at storage 722 and/or at storage of one or more of user equipment devices 707, 708, 709, 710.

In some embodiments, server 704 may include control circuitry 711 and storage 714 (e.g., RAM, ROM, Hard Disk, Removable Disk, etc.). Storage 714 may store one or more databases. Server 704 may also include an input/output path 712. I/O path 712 may provide zone based streaming data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 (and specifically control circuitry) to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 711 executes instructions for an emulation system application stored in memory (e.g., the storage 714). Memory may be an electronic storage device provided as storage 714 that is part of control circuitry 711.

Edge computing device 716 may comprise control circuitry 718, I/O path 720 and storage 722, which may be implemented in a similar manner as control circuitry 711, I/O path 712 and storage 724, respectively of server 704. Edge computing device 716 may be configured to be in communication with one or more of user equipment devices 707, 708, 709, 710 and video server 704 over communication network 706, and may be configured to perform processing tasks (e.g., zone based streaming) in connection with ongoing processing of video data. In some embodiments, a plurality of edge computing devices 716 may be strategically located at various geographic locations, and may be mobile edge computing devices configured to provide processing support for mobile devices at various geographical regions.

FIGS. 8A-B, 9A-B, and 10 are flowcharts of a detailed illustrative processes, in accordance with some embodiments of this disclosure. In various embodiments, the individual steps of processes 800, 820, 900, 920, and 1000 may be implemented by one or more components of the devices and systems of FIGS. 1, 6, and 7. Although the present disclosure may describe certain steps of processes 800, 820, 900, 920, and 1000 (and of other processes described herein) as being implemented by certain components of the devices and systems of FIGS. 1, 6, and 7, this is for purposes of illustration only, and it should be understood that other components of the devices and systems of FIGS. 1, 6, and 7 may implement those steps instead.

FIG. 8A is a flowchart of a detailed illustrative process 800 for preparing a server bitstream, in accordance with some embodiments of this disclosure.

At step 802, control circuitry (e.g., control circuitry 718 of FIG. 7) of a computing device (e.g., server 102) pre-encodes coarse, medium, and fine-grained tiles per picture.

At step 804, control circuitry encodes each tile as one NAL bitstream.

FIG. 8B is a flowchart of a detailed illustrative process 820 using asymmetrically and progressively tiling video content for a client device, in accordance with some embodiments of this disclosure.

At step 822, control circuitry (e.g., circuitry 718 of FIG. 7) of a computing device (e.g., client device 110) calculates the user viewport position.

At step 824, input/output circuitry (e.g., circuitry 720 of FIG. 7) of a computing device (e.g., client device 110) requests largest tile chunk(s) for the viewport.

At step 826, input/output circuitry requests the next largest tile chunks for the adjacent area of the viewport progressively (pre-fetching).

At step 828, control circuitry determines whether the viewport moved. The control circuitry may determine the viewport moved by calculating a current user viewport position, and comparing the current user viewport position to the previous user viewport position that was calculated at step 822. If the viewport moved (e.g., control circuitry determines a change in user viewport position), then control circuitry proceeds to decode and display the tile chunks from adjacent area and then proceeds to step 824. When proceeding to step 824, the control circuitry may apply the current user viewport position at step 824 to request the largest tile chunk(s) for the viewport at the current user viewport position. If the viewport has not moved (e.g., the current user viewport position is a same position as the previous user viewport position), then the control circuitry proceeds to step 832.

At step 832, control circuitry decodes and displays the largest tile chunk(s) for the viewport.

FIG. 9A is a flowchart of a detailed illustrative process 900 for asymmetric and progressive tiling for viewport area, in accordance with some embodiments of this disclosure. At step 902, control circuitry (e.g., circuitry 718 of FIG. 7) of a computing device (e.g., server 102) applies DL-based learning algorithm on viewport dataset to generate saliency map.

At step 904, control circuitry asymmetrically and progressively tile video content based on the saliency map.

At step 906, control circuitry may apply different QP allocation for tiles. In some embodiments, step 906 is optional.

At step 908, input/output circuitry (e.g., circuitry 720 of FIG. 7) of a computing device (e.g., server 102) transmits and reacts to user viewport movement.

FIG. 9B is a flowchart of a detailed illustrative process 920 for determining tile-size for video content, in accordance with some embodiments of this disclosure.

At step 922, control circuitry (e.g., circuitry 718 of FIG. 7) of a computing device (e.g., server 102) selects largest ROI object from a saliency map or DL-based object detection such as You only look once (YOLO) (intra-picture period).

At step 924, control circuitry measures (i) distance and (ii) object type between neighboring objects.

At step 926, control circuitry binds same-type objects considering overlapping and threshold. For example, binding may occur if (i) distance and (ii) object type between neighboring objects are less than a threshold.

At step 928, control circuitry decides tile-size adaptively. For example, when objects are overlapped with each other, control circuitry decides the tile size to cover the object considering the motion prediction performance. Near from ROI, control circuitry may apply coarse-grained tiles and far from ROI, control circuitry may apply fine-grained tiles.

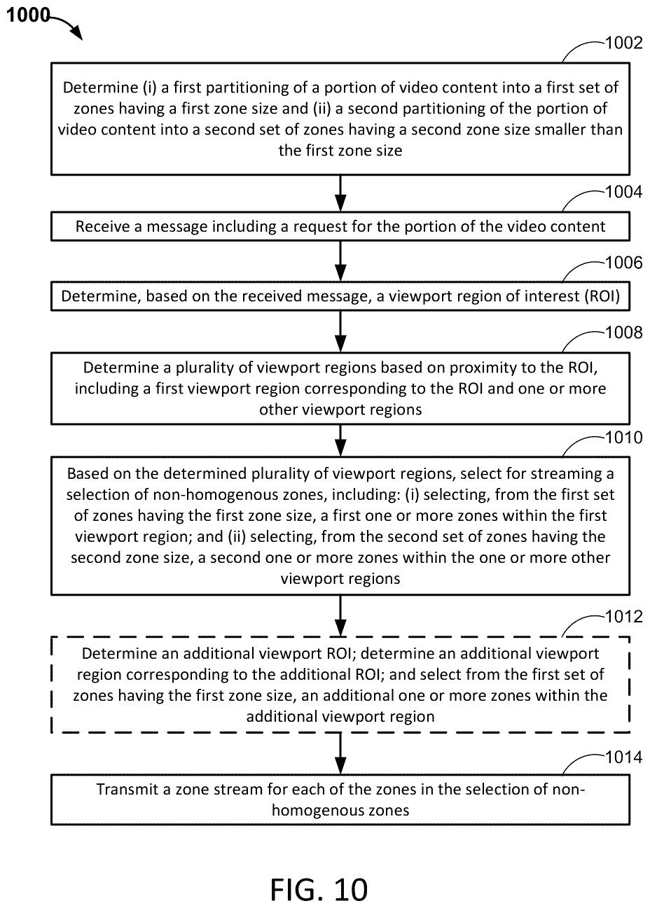

FIG. 10 is a flowchart of a detailed illustrative process for determining tile-size for video content, in accordance with some embodiments of this disclosure.

At step 1002, control circuitry (e.g., circuitry 718 of FIG. 7) of a computing device (e.g., server 102) may determine (i) a first partitioning of a portion of video content into a first set of zones having a first zone size and (ii) a second partitioning of the portion of video content into a second set of zones having a second zone size smaller than the first zone size. In some embodiments, a zone may be a tile, a slice, or a sub-picture. In some embodiments, the zones within the first set of zones are uniform relative to each other and wherein the zones within the second set of zones are uniform relative to each other. In some embodiments, the zones within the first set of zones are sized according to proximity to a predicted ROI. For example, there may be multiple partitions of a single frame. One of the partitions may be based on a salience map. One (or multiple other) partitions may be sized uniformly and not based on prediction.

At step 1004, control circuitry may receive a message including a request for the portion of the video content. For example, a client device 110 of FIG. 1 may request a portion 124 of the video content 112.

At step 1006, control circuitry may determine, based on the received message, a viewport region of interest (ROI). For example, a viewport ROI may be a center of field of view. As an example, for instance, FIG. 1 shows a viewport ROI 120. A viewport ROI may be region(s) of interest based on a salience map, a size of detected objects in screen, analysis of what other users viewed with in the FoV, etc. Accordingly, in some embodiments, there may be multiple regions of interest (e.g., multiple distinct regions for large tiles).

At step 1008, control circuitry may determine a plurality of viewport regions based on proximity to the ROI, including a first viewport region corresponding to the ROI and one or more other viewport regions. For example, the first viewport region may be a same size as and overlap exactly with the ROI. As another example, the first viewport region may be a different size as the ROI (e.g., larger). For example, in some instances, the ROI may a point in the middle of the field of view (FoV). For example, in other instances, the ROI may be a region that takes up a percentage (e.g., 25%) of the middle of the FoV. As an example, for instance, FIG. 1 shows a first viewport region 122 corresponding to the ROI 120, and the ROI 120 may be a point in the middle of the FoV 125. In some embodiments, the first viewport region 122 may be a same size and overlap exactly with the ROI 120.

At step 1010, control circuitry may, based on the determined plurality of viewport regions, select for streaming a selection of non-homogenous zones. The selection of non-homogenous zones may include selecting, from the first set of zones having the first zone size, a first one or more zones within the first viewport region. The selection of non-homogenous zones may also include selecting, from the second set of zones having the second zone size, a second one or more zones within the one or more other viewport regions. As an example, for instance, FIG. 1 shows server 102 may select first zones 114 within the first viewport region 122 having the first zone size, and second zones 116 within the other viewport region 124 (region outside first viewport region 122 marked by other viewport region 124).

At step 1012, control circuitry may determine an additional viewport ROI. The system may determine an additional viewport region corresponding to the additional ROI. The system may select from the first set of zones having the first zone size, an additional one or more zones within the additional viewport region, where the transmitting the zone stream for each of the zones includes the additional one or more zones. In some embodiments, step 1012 is optional.

At step 1014, input/output circuitry (e.g., circuitry 720 of FIG. 7) of a computing device (e.g., server 102) may transmit a zone stream for each of the zones in the selection of non-homogenous zones.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
determining (i) a first partitioning of a portion of video content into a first set of zones having a first zone size and (ii) a second partitioning of the portion of video content into a second set of zones having a second zone size smaller than the first zone size;
receiving a message including a request for the portion of the video content;
determining, based on the received message, a viewport region of interest (ROI);
determining a plurality of viewport regions based on proximity to the ROI, including a first viewport region corresponding to the ROI and one or more other viewport regions; and based on the determined plurality of viewport regions, selecting for streaming a selection of non-homogenous zones, including: (i) selecting, from the first set of zones having the first zone size, a first one or more zones within the first viewport region; and (ii) selecting, from the second set of zones having the second zone size, a second one or more zones within the one or more other viewport regions; and
transmitting a zone stream for each of the zones in the selection of non-homogenous zones.

2. The method of claim 1, wherein the zones within the first set of zones are uniform relative to each other and wherein the zones within the second set of zones are uniform relative to each other.

3. The method of claim 1, wherein the zones within the first set of zones are sized according to proximity to a predicted ROI.

4. The method of claim 1, wherein the ROI is based on a center of a field of view of a user associated with a head mounted display requesting the portion of the video content.

5. The method of claim 1, wherein the ROI is based on detected objects in the portion of the video content.

6. The method of claim 1, wherein the ROI is based on an analysis of a center of a field of view of one or more other users that viewed the portion of video content that is within a field of view of a user associated with a head mounted display requesting the portion of the video content.

7. The method of claim 1, further comprising:
determining an additional viewport ROI;
determining an additional viewport region corresponding to the additional ROI; and
selecting from the first set of zones having the first zone size, an additional one or more zones within the additional viewport region,
wherein the transmitting the zone stream for each of the zones includes the additional one or more zones.

8. The method of claim 1, wherein the first viewport region is a same size as the ROI.

9. The method of claim 1, wherein the first viewport region is a percentage of an area of a field of view of a user associated with a head mounted display requesting the portion of the video content.

10. The method of claim 1, wherein the ROI is a point that is at a center of a field of view of a user associated with a head mounted display requesting the portion of the video content.

11. A system comprising:
control circuitry configured to:
determine (i) a first partitioning of a portion of video content into a first set of zones having a first zone size and (ii) a second partitioning of the portion of video content into a second set of zones having a second zone size smaller than the first zone size;
receive a message including a request for the portion of the video content;
determine, based on the received message, a viewport region of interest (ROI);
determine a plurality of viewport regions based on proximity to the ROI, including a first viewport region corresponding to the ROI and one or more other viewport regions; and
based on the determined plurality of viewport regions, select for streaming a selection of non-homogenous zones, including:
(i) select, from the first set of zones having the first zone size, a first one or more zones within the first viewport region; and
(ii) select, from the second set of zones having the second zone size, a second one or more zones within the one or more other viewport regions; and
input/output circuitry configured to:
transmit a zone stream for each of the zones in the selection of non-homogenous zones.

12. The system of claim 11, wherein the zones within the first set of zones are uniform relative to each other and wherein the zones within the second set of zones are uniform relative to each other.

13. The system of claim 11, wherein the zones within the first set of zones are sized according to proximity to a predicted ROI.

14. The system of claim 11, wherein the ROI is based on a center of a field of view of a user associated with a head mounted display requesting the portion of the video content.

15. The system of claim 11, wherein the ROI is based on detected objects in the portion of the video content.

16. The system of claim 11, wherein the ROI is based on an analysis of a center of a field of view of one or more other users that viewed the portion of video content that is within a field of view of a user associated with a head mounted display requesting the portion of the video content.

17. The system of claim 11, wherein the control circuitry is further configured to:
determine an additional viewport ROI
determine an additional viewport region corresponding to the additional ROI; and
select from the first set of zones having the first zone size, an additional one or more zones within the additional viewport region, and
wherein the input/output circuitry configured to transmit the zone stream for each of the zones includes the additional one or more zones.

18. The system of claim 11, wherein the first viewport region is a same size as the ROI.

19. The system of claim 11, wherein the first viewport region is a percentage of an area of a field of view of a user associated with a head mounted display requesting the portion of the video content.

20. The system of claim 11, wherein the ROI is a point that is at a center of a field of view of a user associated with a head mounted display requesting the portion of the video content.

21-50. (canceled)
